(19) United States
(12) Patent Application Publication
(10) Pub. No.: US 2015/0273983 A1
(43) Pub. Date: Oct. 1, 2015

(54) VEHICLE CLUTCH HAVING POWER TRANSMISSION INTERRUPTION UNIT

(71) Applicant: Gn1 Co., Ltd., Chilgok-gun (KR)

(72) Inventor: BAE KYEONG KIM, Daegu (KR)

(73) Assignee: Gn1 Co., Ltd., Chilgok-gun (KR)

(21) Appl. No.: 14/230,341

(22) Filed: Mar. 31, 2014

(51) Int. Cl. B60H 1/32; F16D 7/02

(52) U.S. Cl. CPC B60H 1/3222; F16D 7/024; B60H 1/3225

(57) ABSTRACT

A vehicle clutch having a power transmission interruption unit, including: a first rotor connected to a prime mover; a second rotor connected to the first rotor; elastic intermediate members for transmitting power from the first rotor to the second rotor or interrupting the power transmission, the intermediate members being mounted to one of the first and second rotors at first ends and being elastically coupled to a remaining one of the two rotors at second ends; and support members corresponding to the intermediate members, each support member including a head having protrusions and a shank extended from the head, wherein the second ends of the intermediate members are elastically coupled to the first or second rotor by the shanks such that the intermediate members can be released from the elastically coupled state, and the heads of the support members come into surface contact with the intermediate members by the protrusions.

### BACKGROUND OF THE INVENTION

1. Field of the Invention

The present invention relates, in general, to a vehicle clutch having a power transmission interruption unit that can interrupt power transmitted from the clutch to an air conditioner of a vehicle when the air conditioner is overloaded, and, more particularly, to a vehicle clutch having a power transmission interruption unit in which, when the air conditioner of the vehicle is overloaded, the power transmission interruption unit can interrupt the power transmission of the clutch that transmits engine power to the air conditioner, so the power transmission interruption unit can efficiently interrupt power transmitted from the clutch to the air conditioner without damaging or breaking an engine, the air conditioner, the clutch and parts thereof.

2. Description of the Related Art

Generally, a clutch is a device that can transmit a rotational motion of a drive shaft connected to a prime mover to a driven shaft connected to a load. Here, the clutch is configured to transmit power to the driven shaft or to intercept the power transmission when necessary, and the power transmission between the drive shaft and the driven shaft is typically performed using gears or belts. When such a clutch is used in a vehicle, the power transmission of the clutch is mainly used to drive the vehicle and is also used to operate an air conditioner equipped in the vehicle.

To operate an air conditioner of a vehicle, engine power is primarily transmitted to a clutch using a belt. Upon receiving the engine power, the clutch transmits the engine power to a compressor shaft of the air conditioner, thereby operating the air conditioner. Here, to control the operation of the compressor, a user appropriately manipulates air conditioner control buttons installed inside a passenger compartment of the vehicle, thereby starting or stopping the power transmission between the engine, the clutch and the air conditioner.

Once the operation of the air conditioner is started, the air conditioner will continue the operation until a user controls the operation of the air conditioner as desired. Here, the continuous operation may impose an overload on the air conditioner, and, even when the air conditioner is overloaded, the user may not be aware of the overloaded state of the air conditioner; therefore the overloaded state of the air conditioner may damage or break the parts of the vehicle.

Thus, in an effort to prevent the parts of the vehicle from being damaged or broken due to the overloaded air conditioner without disturbing normal driving of the vehicle, a device for interrupting the power transmission between the engine, the clutch and the air conditioner has been developed and proposed. Particularly, in recent years, as a coilless clutch has been developed to form a link in the chain of lightness of vehicle parts, the technology relating to the power transmission interruption unit of the clutch has been actively studied and developed. As a conventional technology of interrupting the power transmission between the engine, the clutch and the air conditioner, a destructive interruption method of breaking a connection member that connects the clutch to the compressor of the air conditioner when the air conditioner is overloaded with a torque not less than a limit torque, was proposed. However, this destructive interruption method is problematic in that, when the connection member is broken, it is required to change damaged or broken parts with new parts after disassembling all the parts associated with the clutch. Another problem of the destructive interruption method resides in that the action of breaking the connection member may cause damage or breakage of parts installed around the connection member.

In recent years, a non-destructive interruption method in which the connected state of the connection member can be simply disconnected without breaking the connection member, thereby interrupting the power transmission of the clutch and allowing a user to reuse the connection member. The non-destructive interruption method is advantageous in that the method can prevent damage or breakage of parts installed around the connection member which may be caused when breaking the connection member.

However, both the destructive interruption method and the non-destructive interruption method are problematic in that it is required to realize a desired balance between the rotational power or the torque that is transmitted from the engine to the clutch and then to the air conditioner and both an elastic force and a frictional force acting between the clutch and the air conditioner. In other words, when the desired balance between the above-mentioned forces is not realized, the methods may suddenly interrupt the power transmission even when the air conditioner is slightly overloaded to a low level that does not require interruption of the power transmission, or the methods may fail to interrupt the power transmission even when the air conditioner is highly overloaded to a level requiring interruption of the power transmission. Accordingly, all the two types of power transmission interruption methods are problematic in that the methods may easily cause misoperation of the clutch.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a vehicle clutch having a power transmission interruption unit, in which the frictional forces of intermediate members that function to transmit power of a prime mover to an air conditioner or to interrupt the power transmission are increased, so a desired balance between a torque output from the prime mover and a load imposed on the air conditioner can be realized, and the power transmission interruption unit can reliably interrupt the power transmission from the prime mover to the air conditioner when the air conditioner is highly overloaded and can continue the power transmission without suddenly interrupting the power transmission when the air conditioner is less overloaded, thereby preventing misoperation of the clutch.

The present invention is also intended to propose a vehicle clutch having a power transmission interruption unit, in which the increase in the frictional forces of the intermediate members can be realized with a simple construction of the clutch having the power transmission interruption unit, so the clutch having the power transmission interruption unit can be efficiently produced at low cost and through a simple process.

In order to achieve the above object, according to one aspect of the present invention, there is provided a vehicle clutch having the power transmission interruption unit, including a first rotor that receives power from a prime mover, and a second rotor that is connected to the first rotor and is rotated by power transmitted from the first rotor. Further, a plurality of elastic intermediate members are arranged between the first and second rotors so as to transmit power from the first rotor to the second rotor and to interrupt the power transmission from the first rotor to a loaded device, such as an air conditioner, via the second rotor when the loaded device is highly overloaded to a level higher than a limit torque.

The power transmission between the first and second rotors, the power transmission between the second rotor and the loaded device, such as the air conditioner, and the interruption of power transmission can be realized by locking the first ends of the intermediate members to one of the first and second rotors and by elastically coupling the second ends of the intermediate members to a remaining one of the first and second rotors. In other words, the interruption of power transmission from the second rotor to the air conditioner can be realized by releasing the elastically coupled state of the second ends of the intermediate members relative to the first or second rotor when the air conditioner is highly overloaded to a level higher than a limit torque.

The clutch of the present invention also includes a plurality of support members that are provided so as to correspond to the plurality of the intermediate members. Each of the support members includes a head having a plurality of protrusions and a shank extended from the head. Here, the second ends of the intermediate members are elastically coupled to the remaining one of the first and second rotors by the shanks of the support members such that the second ends can be released from the elastically coupled state, and the heads of the support members come into surface contact with the respective intermediate members by the plurality of protrusions.

As described above, in the vehicle clutch having the power transmission interruption unit according to the present invention, the frictional forces of intermediate members that function to transmit power of a prime mover to an air conditioner or to interrupt the power transmission are increased, so the power transmission interruption unit can reliably interrupt the power transmission from the prime mover to the air conditioner when the air conditioner is highly overloaded and can continue the power transmission without suddenly interrupting the power transmission when the air conditioner is less overloaded, thereby preventing vehicle parts from being damaged or broken and preventing the clutch from requiring repair. If the power transmission from the prime mover to the air conditioner is suddenly interrupted when the air conditioner is less overloaded, the clutch should be repaired to restore normal operation thereof. On the contrary, if the power transmission from the prime mover to the air conditioner is not interrupted when the air conditioner is highly overloaded, parts of the vehicle may be damaged or broken.

Further, in the vehicle clutch according to the present invention, the increase in the frictional forces of the intermediate members can be realized with a simple construction of the clutch, so the present invention can provide a structurally improved clutch that can be produced at low cost and through a simple process.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a front view of a clutch according to the present invention;

FIG. 2 is a sectional view taken along line A-A of [symbol] FIG. 1;

FIG. 3 is an exploded perspective view of the clutch according to the present invention;

FIG. 4 is a rear view of a support members used in the clutch according to the present invention; and

FIG. 5 is a sectional view taken along line B-B of FIG. 4.

### DETAILED DESCRIPTION OF THE INVENTION

Hereinbelow, preferred embodiments of the present invention will be described in detail with reference to the accompanying drawings.

A vehicle clutch having a power transmission interruption unit according to an embodiment of the present invention will be described hereinbelow with reference to the accompanying drawings.

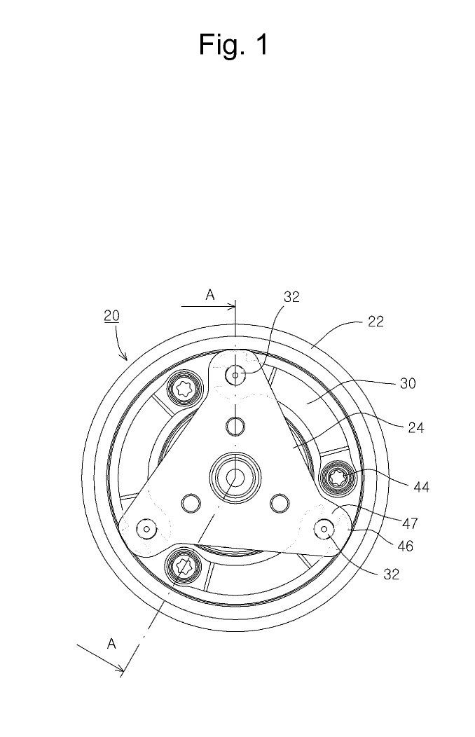

With reference to FIG. 1, a vehicle clutch 20 having a power transmission interruption unit according to the present invention includes: a first rotor 22 that is connected to a drive shaft of a prime mover, such as a vehicle engine, and transmits power of the prime mover to an air conditioner that is a driven device; a second rotor 24 that is connected to the first rotor 22 so as to be rotated along with the first rotor 22; a plurality of intermediate members 30 that are interposed between the first rotor 22 and the second rotor 24 and can transmit power of the first rotor 22 to the second rotor 24 or can interrupt the power transmission; and a plurality of support members 32 that are provided so as to correspond to the plurality of intermediate members 30 and to releasably hold second ends of the intermediate members 30 on the second rotor 24.

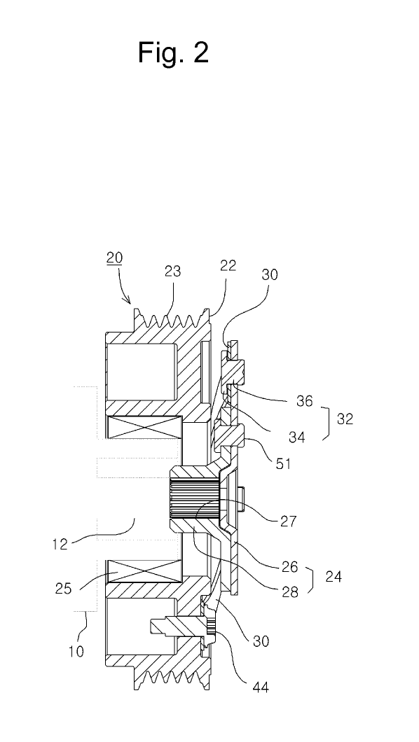

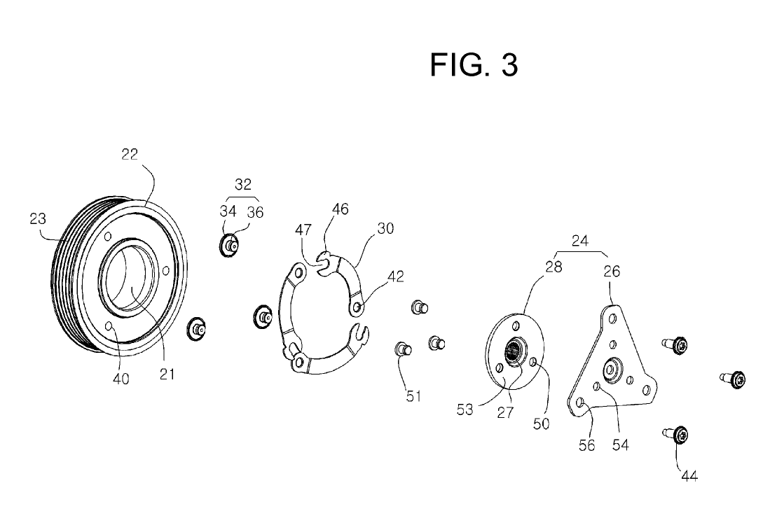

Here, the second ends of the intermediate members 30 are disconnectably coupled to an arm 26 of the second rotor 24 in such a way that the second ends of the intermediate members 30 can be disconnected from the arm 26 of the second rotor 24. The disconnectable connection of the intermediate members 30 to the second rotor 24 will be described later herein with reference to FIGS. 2 and 3. Here, first ends of the intermediate members 30 are locked to the first rotor 22 using respective locking members 44, such as locking screws. The first rotor 22 is provided with a grooved rim 23 for carrying a belt (not shown) that transmits power of the prime mover to the first rotor 22. The second rotor 24 includes an arm 26 and a hub 28. Here, the arm 26 and the hub 28 are locked together using rivets 51. Further, each of the support members 32 includes a head 34 and a shank 36.

The hub 28 is combined with a spline shaft 27, and a rotating shaft 12 of a compressor 10 of the air conditioner is rotatably combined with the second rotor 24 that includes both the arm 26 and the hub 28, so the rotating shaft 12 can be rotated together with the second rotor 24. Here, the clutch 20 is mounted to a front housing of the compressor 10 with a bearing 25 installed between the clutch 20 and the front housing of the compressor 10.

A rotating force of the drive shaft of the prime mover is primarily transmitted to the first rotor 22 by the belt, and the rotating force that has been transmitted to the first rotor 22 is then transmitted to the second rotor 24 having both the arm 26 and the hub 28 via the intermediate members 30. Here, both the arm 26 and the hub 28 that constitute the second rotor 24 are combined with the rotating shaft 12 of the compressor 10, so the rotating force that has been transmitted to the second rotor 24 is then transmitted to the compressor 10 and operates the air conditioner.

When the air conditioner is overloaded during the operation of the air conditioner having the compressor 10 which is operated by the rotating force of the prime mover, the second ends of the intermediate members 30 are released from the respective support members 32, and the frictional contact of the second ends of the intermediate members 30 with the arm is released, so the intermediate members 30 elastically restore their original shapes and positions by their elasticity. Accordingly, power transmission from the first rotor 22 to the second rotor 24 is interrupted.

Therefore, the rotating force of the prime mover is not further transmitted to the compressor 10, so it is possible to prevent the clutch 20 from being damaged or broken due to the overloaded air conditioner. Although the power transmission from the prime mover to the air conditioner is interrupted as described above, the power transmission from the prime mover to the other parts of the vehicle, such as electric/electronic devices, is not interrupted, so the parts can continue their operations without being affected by the interruption.

Further, as described above, the intermediate members 30 can interrupt the power transmission from the clutch 20 to the compressor 10 by elastically restoring their original shapes and positions without being damaged or broken, so the normal operation of the clutch 20 can be easily restored by a simple repair. Further, the clutch of the present invention can interrupt the power transmission from the prime mover to the air conditioner without damaging or breaking the parts of the clutch 20, such as the intermediate members 30, so the present invention does not cause secondary damage or breakage of the other parts of the vehicle which may be caused by the damage or breakage of the parts of the clutch 20, such as the intermediate members 30.

The construction of the clutch 20 of the present invention will be described in detail hereinbelow with reference to FIGS. 2 and 3. As shown in FIGS. 2 and 3, the first rotor 22 of the clutch 20 is connected to the rotating shaft of the prime mover, such as an engine, by a power connection means, such as a belt, thereby being rotated together with the rotating shaft of the prime mover. The outer circumferential surface of the first rotor 22 is grooved, thereby forming the grooved rim 23 for carrying the belt. Further, the first rotor 22 is provided with a central opening 21 for mounting the clutch 20 to the front housing of the compressor 10. The front surface of the first rotor 22 is provided with a plurality of locking holes 40 for locking the first ends of the intermediate members 32 to the first rotor 22.

In this embodiment, the clutch 20 has three intermediate members 30, as an example. Each of the intermediate members 30 has an arcuate band shape, with a locking hole 42 and a yoke-shaped grip part 46 formed in opposite ends of each intermediate member 30. The grip part 46 is cut to a predetermined length along the central axis thereof, thus forming a groove 47, so the grip part 46 has a yoke shape. Each of the intermediate members 30 may be made of an elastic material having predetermined elasticity. The number of the support members 32 is determined corresponding to the number of the intermediate members 30, so the numbers of the support members 32 and the intermediate members 30 are equal to each other. The support members 32 are received in the grooves 47 of the grip parts 46 of the respective intermediate members 30, thereby holding the grip parts 46 on the second rotor 24. The detailed shape of the support members 32 will be described later herein.

The arm 26 and the hub 28 are elements that constitute the second rotor 24 that is a part combined with the rotating shaft 12 of the air conditioner compressor 10. Here, the hub 28 includes the spline shaft 27 that is combined with the rotating shaft 12 of the compressor 10, and a contact plate 53 that is integrally formed on an end of the spline shaft 27 and comes into surface contact with the hub 28. The contact plate 53 is provided with a plurality of rivet holes 50, so the contact plate 53 can be mounted to the arm 26 using rivets 51. Here, the arm 26 and the hub 28 may be integrally formed as a single structure.

The arm 26 is provided with a plurality of rivet holes 54 through which the arm 26 is combined with the hub 28 using the rivets 51, and with a plurality of holding holes 56 for holding the second ends of the intermediate members 30.

To assemble the above-mentioned parts of the clutch 20 into a single body, the first ends of the intermediate members 30 are locked to the front surface of the first rotor 22 using the locking members 44 that pass both through the respective locking holes 42 of the intermediate members 30 and through the respective locking holes 40 of the first rotor 22. Here, the first ends of the intermediate members 30 may be locked to the arm 26 instead of being locked to the first rotor 22.

Further, to form the second rotor 24, the hub 28 and the arm 26 are combined with each other using rivets 51 that pass both through the rivet holes 50 of the hub 28 and through the rivet holes 54 of the arm 26. Here, the first rotor 22 and the second rotor 24 are separate parts, in which the rotating force of the first rotor 22 is transmitted to the second rotor 24 via the intermediate members 30, and the second rotor 24 is combined with the rotating shaft 12 of the compressor 10, so the rotating force of the second rotor 24 is transmitted to the rotating shaft 12 of the compressor 10, thereby rotating the rotating shaft 12 of the compressor 10.

In the above state, the second ends of the intermediate members 30 are brought into frictional contact with the arm 26 in an elastically deformed state at locations corresponding to the respective holding holes 56 of the arm 26. In other words, the second ends of the intermediate members 30 are releasably caught on the rear surface of the arm 26 in the elastically deformed state by the support members 32, the grip parts 46 and the holding holes 56 of the arm 26. Here, when the first ends of the intermediate members 30 are locked to the arm 26 instead of being locked to the first rotor 22, the elastically deformed ends of the intermediate members 30 may be caught on the first rotor 22 instead of being caught on the arm 26.

As described above, the second ends of the intermediate members 30 are releasably caught in an elastically deformed state by the support members 32, the grip parts 46 and the holding holes 56, so, when the air conditioner is highly overloaded to a level exceeding a limit torque, the second ends of the intermediate members 30 may be released from a combined state with the arm 26 which has been maintained by the following three forces: an elastic force formed by the elastic deformation of the intermediate members 30, a frictional force generated between the arm 26 and the intermediate members 30, and a gripping force formed by the grip parts 46. When the intermediate members 30 are released from the combined state with the arm 26, the intermediate members 30 elastically restore their original shapes, so the rotating force that has been transmitted to the rotating shaft 12 of the compressor 10 by the arm 26 (that is, the second rotor 24) is interrupted. Accordingly, the rotating force of the prime mover that has been transmitted to the first rotor 22 of the clutch 20 is not further transmitted to the air conditioner.

When the power of the prime mover (a rotating force or a torque that will be transmitted to the other devices requiring power in addition to the air conditioner) is transmitted to the clutch 20, at least four forces act on the clutch 20. Here, the rotating force or the torque output from the prime mover is one of the four forces, and is transmitted to the clutch 20, and is then transmitted to the air conditioner from the clutch 20, thereby operating the air conditioner. The remaining three forces of the four forces are the elastic force, the frictional force and the gripping force which are generated by the parts constituting the clutch 20.

Here, the elastic force is generated between the intermediate members 30 and the arm 26 of the second rotor 24. That is, the elastically deformed second ends of the intermediate members 30 are brought into frictional contact with the arm 26 at locations corresponding to the holding holes 56 of the arm 26. As described above, the second ends of the intermediate members 30 are elastically coupled to the arm 26 in an elastically deformed state, so the elastic force that is formed by the elastic deformation of the intermediate members 30 functions as a force that can maintain the combination of the intermediate members 30 with the second rotor 24 or with the arm 26. Here, the elastic force formed by the elastically deformed intermediate members 30 may be determined by the intrinsic characteristics of a material of the intermediate members 30 and by a process of producing the intermediate members 30.

The gripping force is generated between the intermediate members 30 and the support members 32. That is, the support members 32 and the grip parts 46 of the intermediate members 30 are combined with each other in an elastically deformed state on the rear surface of the arm 26 at the locations of the holding holes 56 of the arm 26, so the gripping force is generated. Here, the gripping force may be increased by structurally deforming the grooves 47 of the grip parts 46.

The frictional force is generated from the contact surfaces between the support members 32 and the arm 26 and from the contact surfaces between the intermediate members 30 and the surface of the arm 26. Here, the kinetic frictional force is determined in proportion to a normal force N. Further, the kinetic frictional force relates to surface roughness of a contact surface, and the surface roughness is determined by surface flatness. In other words, the frictional force is increased in proportion to the surface roughness of a matter, and the total frictional force of a matter can be increased when the surface of the matter is machined such that the surface becomes evenly rough over the total surface of the matter without machining the surface such that the surface becomes partially rough on a point or on a part of the surface. Here, to realize desired flatness of a surface, it is more efficient to machine the surface in a state of dividing the surface into several parts than machining the surface as a single surface.

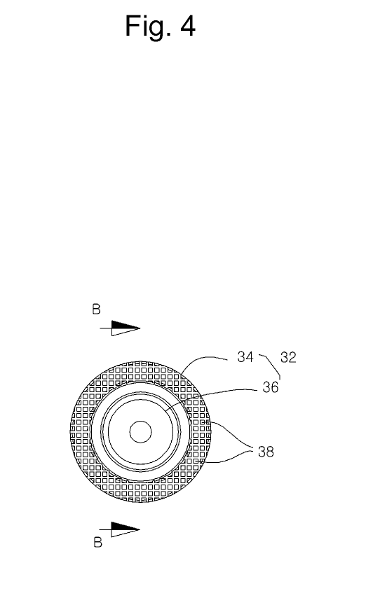

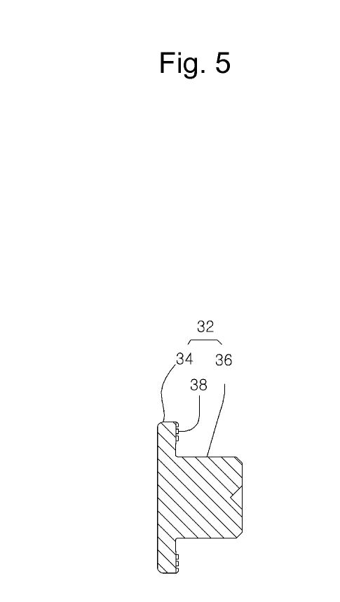

As shown in FIGS. 4 and 5, each of the support members 32 has a head 34 and a shank 36. Here, the shank 36 functions to catch the elastically deformed intermediate members 30 on the rear surface of the arm 26 using relationship between the grip parts 46 of the intermediate members 30 and the holding holes 56 of the arm 26. Further, the head 34 functions to bring the grip part 46 of an associated intermediate member 30 into pressure contact with a surface around an associated holding hole 56 of the arm 26, thereby bringing the grip part 46 into close surface contact with the arm 26 and preventing the intermediate member 30 from being suddenly released due to a shock, such as vibrations.

The above-mentioned functions of the support members 32 are improved in proportion to the degree of contact between the heads 34 of the support members 32 and the grip parts 46 of the intermediate members 30. Further, the improved functions of the support members 32 increase the gripping force formed between the heads 34 and the grip parts 46. To increase both the degree of contact and the gripping force, it is more efficient to perform flat machining on the surface of the head 34 in a state of dividing the surface into several parts than performing the flat machining on the surface of the head 34 as a single surface. In an effort to realize the increase in both the degree of contact and the gripping force, a plurality of protrusions 38 may be formed on each of the heads 34 of the support members 32. Here, the protrusions 38 may have a circular or elliptical cross-section.

Further, due to the protrusions 38 formed on the head 34, it is possible to finely control the gripping force. When each of the heads 34 of the support members 32 is machined to form a flat surface without having protrusions 38, the flatness of the head 34 will be determined by a single process of machining each support member 32, and a partial deviation will be present in the flatness of the head 34 machined through the above-mentioned single process, and it is difficult to correct the partial deviation in the flatness of the head 34.

On the contrary, when forming the protrusions 38 on the head 34, it is easy to realize even flatness over the surface of the head 34. In other words, when a surface area (bare surface area) of the head 34 having no protrusions 38 is set to 100, and when protrusions 38 of which the sum of total surface areas becomes 80˜90% of the bare surface area are formed on the head 34, it is very easy to control the surface flatness of the head 34. That is, when the cross-sectional surface area of a protrusion 38 is determined, it is possible to realize desired surface flatness by controlling the number of the protrusions 38 in such a way that the sum of total surface areas of the protrusions 38 becomes 80˜90% of the bare surface area. Accordingly, it is possible to control the overload or over torque by controlling the cross-sectional surface area of each of the protrusions 38, as described above.

Depressions (not shown) may be formed on each of the grip parts 46 of the intermediate members 30 at locations corresponding to the respective protrusions 38 of the support members 32. Here, each of the depressions may be configured to receive therein a part of an end of an associated protrusion 38, so it is possible to realize reliable combination of the intermediate members 30 with the support members 32, and to realize reliable frictional contact between the intermediate members 30 and the arm 26.

As described above, by appropriately designing the protrusions 38, it is possible to efficiently control the total flatness and to efficiently control the gripping force of the support members 32, so the power transmission between the intermediate members 30 and the second rotor 24 and the interruption of the power transmission can be finely controlled.

As described above, in the present invention having a simple construction in which the protrusions 38 are formed on each of the heads 34 of the support members 32, it is possible to finely control the gripping force that is generated between the arm 26, the intermediate members 30 and the support members 32. Due to the fine control of the gripping force, the present invention can prevent sudden interruption of power transmission from the clutch 20 to the air conditioner when the air conditioner is less overloaded such that it is required to continue the power transmission without interruption. Further, the present invention improves the function of the clutch 20 such that the clutch 20 can reliably interrupt the power transmission from the clutch to the air conditioner when the air conditioner is highly overloaded.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A vehicle clutch having a power transmission interruption unit, comprising:
a first rotor that receives power from a prime mover;
a second rotor that is connected to the first rotor and is rotated by power transmitted from the first rotor;
a plurality of elastic intermediate members that transmit the power of the first rotor to the second rotor and interrupt power transmission from the first rotor to other parts via the second rotor when overloaded, the intermediate members being mounted to one of the first and second rotors at first ends thereof and being elastically coupled to a remaining one of the first and second rotors at second ends thereof; and
a plurality of support members that are provided so as to correspond to the respective intermediate members, each of the support members including a head having a plurality of protrusions and a shank extended from the head, wherein
the second ends of the intermediate members are elastically coupled to the remaining one of the first and second rotors by the shanks of the support members such that the second ends can be released from the elastically coupled state, and the heads of the support members come into surface contact with the respective intermediate members by the plurality of protrusions.

2. The vehicle clutch having the power transmission interruption unit as set forth in claim 1, wherein the sum of total surface areas of the protrusions formed on the head of each of the support members becomes 80˜90% of a bare surface area of the head.

3. The vehicle clutch having the power transmission interruption unit as set forth in claim 1, wherein an over torque is controlled by controlling a design of a cross-sectional surface area of each of the protrusions.

4. The vehicle clutch having the power transmission interruption unit as set forth in claim 1, wherein each of the second ends of the intermediate members elastically coupled to the remaining one of the first and second rotors further includes: a grip part provided with a plurality of depressions for receiving therein parts of ends of the protrusions of an associated head.

5. The vehicle clutch having the power transmission interruption unit as set forth in claim 1, wherein the second rotor includes an arm, the first ends of the intermediate members are mounted to the first rotor, and the second ends of the intermediate members are elastically coupled to the arm.
